(19) United States
(12) Patent Application Publication
(10) Pub. No.: US 2012/0046914 A1
(43) Pub. Date: Feb. 23, 2012

(54) HYBRID METHOD FOR DENTAL IMPLANT TREATMENT PLANNING

(76) Inventor: Fei Gao, Cypress, CA (US)

(21) Appl. No.: 12/860,019

(22) Filed: Aug. 20, 2010

(51) Int. Cl. G06F 17/50; A61C 19/04

(52) U.S. Cl. 703/1; 433/72

(57) ABSTRACT

A hybrid method for dental implant treatment planning and a corresponding approach to make a surgical guide. After digital treatment planning is performed with CT scan data, a master model is created, which embodies the patient anatomy and entire treatment plan. Jaw bone, tooth surfaces, soft tissues and nerves are all contained by the master model. The plan details including implant sizes and positions, surgical guide drill options, as well as the choice of a surgical kit, are all conveyed by the master model. Meanwhile, models of specially designed “implant inserts (or replicas)” are also generated, which have one end that fits into the implant holes on the master model and another end to make the surgical guide. The master model and inserts are manufactured with rapid prototyping technology. A surgical guide is later on made from them with conventional lab processes. A main characteristic of this approach is that the master model and the inserts are the physical embodiment of a virtual treatment plan. With them, the surgeons can continue the treatment planning for operations like tooth extractions and bone modifications before making the surgical guides. Therefore the treatment planning workflow is a combination of digital treatment planning and a physical model based planning, in other words, a hybrid approach. A differentiator in this invention is the generation of a closed solid model of the soft tissue, as part of the master model, from the scan data. This approach can be applied to create both bone-borne and tissue-borne surgical guides with low cost process, which is a big advantage over other approaches.

### FIELD OF THE INVENTION

This disclosure is related to dental implant treatment planning, where CT scans of patients and radiographic guides are used to simulate the placement of dental implants. This invention introduces a new workflow combining digital treatment planning and model-based planning. After digital planning, master models and implant replicas are designed and fabricated for the surgeons to further planning the treatment, and for labs to easily make surgical guides and evaluate the applicability of the guides.

### BACKGROUND OF THE INVENTION

In digital implant dentistry, dental implant surgical guides are used to transfer treatment plans into surgical procedures. These guides are made to fit the patients' anatomical structures. They have drilling holes and sleeves to guide the drills so that the drilling positions and locations can be controlled. They also can have features or specifications that, together with the surgical kits, are used to control drilling depths. The treatment plans play a key role to determine the design of surgical guides as well as the manufacturing approaches. Before the computerized approach is introduced, treatment planning is normally done with plaster models with the help of X-rays. In this invention, the workflow integrating the digital treatment planning and model-based planning is concerned, and so is the corresponding surgical guide technology.

One of the dominating approaches of making surgical guides is rapid prototyping (RP). RP or 3D printing can be used to make surgical guides for both flap and flapless surgery. For flap surgery, the surgical guides are designed to fit the jaw bones. They are usually called bone-level or bone-borne guides. The bone models are normally reconstructed from 3D CT scans and serve as the base to design surgical guides. For flapless surgery, the surgical guides are called tissue-borne, because they will be directly placed onto patients' mucosa and/or tooth surfaces. Since it is almost impossible to reconstruct the soft tissue models from patients' CT scan data, radiographic guides are introduced. This technology has been adopted by almost all the commercial software systems for dental implant planning. Materialise and NobelBiocare dominate the surgical guide manufacturing area using RP. Materialise's patent (U.S. Pat. No. 5,768,134, Swaelens) is sometimes misinterpreted or oversimplified as using RP to make surgical guides. It actually does not describe this approach in a more standard way of using rapid prototyping, that is, a CAD system using geometric modeling approach to finish the surgical guide design and then send the models as STL files to RP equipment to make them. Instead, the patent describes a voxel based approach to add form features onto image data and to make the models with RP's capability to generate contours from image data.

While the advantages of using RP are obvious, this state-of-art approach has the following issues. First, the treatment planning is essentially finalized when the surgical guides have been manufactured. Many treatment options such as tooth extraction or bone modifications can be very difficult to address by using these software systems. Secondly the resins used by the RP equipments have to be biocompatible. Such materials are typically expensive, have problems with autoclaving, and are sensitive to heating and humidity. Thirdly, the surgical guides don't come with models of the anatomical structures like plaster models, for the surgeons to prepare the cases and to evaluate the guides. Especially for flap surgery, a jaw bone model is missing, but desired if the surgeons need to evaluate the treatment plan. Moreover for bone-level cases, the jaw bone models segmented by thresholding tend to have problems like small dents and holes, which present big technical challenge to create smooth surgical guides from it (U.S. patent application Ser. No. 12/776,544, Gao).

Milling, by CNC or manual work bench, is also popular in making surgical guides. The radiographic guides are directly used as the surgical guides. Milling machines are used to drill holes on the guides. This is an easy alternative to the method with RP, but it is not an easy task to control the drilling. Special design for the radiographic guides has to be implemented, and procedures to transfer the implant parameters to drilling operations based on such design are required. Keystone Dental's X-marker™ is one of such techniques. Similarly, this approach is not able to handle the situations like tooth extraction. Also it cannot be used for flap surgery.

Schmidt (U.S. patent application Ser. No. 11/867,590) describes a method of creating a surgical drill guide using essentially same technology as NobelGuide™ or EasyGuide™. It has a special designed approach to match the radiographic guide and the patient scan. It creates .stl files, i.e. polygonal models, for the radiographic guide and suggest simulating tooth extraction and shape modification of the bone model before generating the surgical guide. However, neither the actual embodiment nor the complexity of modifying a surface model like this with a computer-aided design system was mentioned. This approach is not for bone-borne cases either.

Poirier (U.S. Pat. No. 6,814,575) introduces a method to make surgical guides and implant superstructure. A radiographic guide with radio-opaque markers is used for treatment planning. The implant positions and orientations are mapped onto a physical model (plaster model), and entered into a CNC machine to drill implant holes on the physical model. It first defines the coordinate system with the jaw model with scanned markers. When the holes are drilled, the guide is placed onto the physical model, and a coordinate measuring machine is used to locate the markers, and create a coordinate system from them. Implant parameters are then mapped into this coordinate system. Finally a drill guide is made by molding with the drilled model and pins inserted into the holes. The approach only works for tissue-borne cases. The approach to map the implant parameters into the drilling parameters is quite complex.

An attempt to increase the accuracy of locating a dental implant in a patient's jawbone is disclosed in U.S. Pat. No. 5,320,529 issued to Pompa. In particular, Pompa discloses a method of determining dental implant placement position by taking a CT scan of the patient's upper or lower jaw and then fabricating a model of that jaw from the reformatted CT scan data. The model is made from a clear plastic/acrylic material into which the surgeon then drills a hole by hand. The surgeon then inserts a dental implant replica (a dummy implant) into the hole and inspects the dummy implant position for acceptability by looking at the dummy implant position through the clear model. A cylinder is then attached to the top of the dummy implant and acrylic is added around the cylinder and on the surface of the jaw model. The acrylic piece with the encased cylinder now becomes a surgical template which rests on top of the patient's jawbone during the actual implant surgery. This is a model-based approach. It determines implant positions manually and can only work for bone-borne cases.

Klein discloses another approach to make surgical guides in U.S. Pat. No. 5,967,777, which uses “scan appliances” or radiographic guides as the base models for surgical guides. Its coordinate system mapping is similar to what is disclosed by Pompa. It defines the coordinate systems similarly and maps them with computer-driven milling machine.

Another criterion to assess the state-of-the-art of the implant treatment planning is the workflow. Surgical guides and the software systems creating the guide models characterize the typical workflow. The CT scan data is acquired and loaded into planning software. The treatment plans are created by the software. Later on surgical guides are designed and made according to the treatment plans. Drilling instructions and the surgical guides are sent to the surgeons and used in the operations.

However, the implant treatment planning workflow is oversimplified in the software systems. In practice the implant software systems do not let the users to create surgical guides (Gao, U.S. patent application Ser. No. 12/795,045), let alone to evaluate the plans with the guide models. All the treatment planning is accomplished completely digitally before the cases are sent for manufacturing. Surgeons can hardly plan anything that is not implemented in the software system, such as bone modification, tooth extraction, etc. Materialise's software does let users to specify bone grafting, tooth extraction, etc. at more or less an abstract or symbolic level. Users don't really have detailed controls over such operations. Because of this, very often the implant sites have to be well prepared and healed before the digital treatment planning can kick in, even though the vendors are trying hard to advocate the concept of same day surgery.

In summary the disclosed approaches to make surgical guides from digital treatment plans can not well satisfy the following requirements:
Both tissue-borne and bone-borne cases can be supported, or, both flapless and flap surgery can be facilitated.
Tooth extraction, bone reduction and grafting can be planned together with the implant placement and before the fabrication of the surgical guides.
The surgical guides can be evaluated by the surgeons with anatomical models and implant replicas.
The actual approach and material to make the surgical guides should be easily available and be lab friendly.

### BRIEF SUMMARY OF THE INVENTION

The objective of this invention is to have a method meeting the aforementioned requirements. This method is capable of making surgical guides for both tissue-borne and bone-borne cases. It enables the surgeons to plan tooth extractions and bone modifications by creating a replica of patient's anatomy. This promotes a hybrid workflow of treatment planning. The implant placement is digitally planned, and then other operations can be planned with a physical model. It is also helpful for the surgeons to evaluate a case and the surgical guide before surgery. The method can take advantage of both digital treatment planning and conventional lab procedures.

The core of the approach is to create digital anatomical models of jaw bone and soft tissues with implant holes added, and manufacture these models as a base for making a surgical guide. The combination of these models integrates the patient's anatomy and treatment plan information. It is called master model in this invention. For mandible (lower jaw) cases, the model will also include nerve channels. Also made are inserts corresponding to the planned implants. An insert is a kind of replica of an implant. It is inserted into the master model and has a part standing out of the soft tissue, so that the surgical guides can be made to match the insert.

The second part of the treatment planning is based on the made master model and the inserts. Using the master model, surgeons can evaluate and modify the treatment plan as desired to reflect treatments like tooth extractions.

At the time of making the surgical guide, the inserts are placed into the master model. Then a conventional lab process is used to make the surgical guide. Specifically, the acrylic molding or other technologies such as EZStent™ (Thermoplastic Surgical Template) can be used to fabricate the surgical guide.

For a tissue-borne case, this approach uses a radiographic guide in the same way as many others do. A patient wearing a radiographic guide is scanned, and then the guide is scanned. Both datasets are loaded into a software system for treatment planning. The two scans are registered or aligned in one coordinate system. The user then specifies implants locations and parameters. Since this is for a tissue-borne case, a virtual model of tissue and jawbone together will have to be created by the software system. The treatment plan is mapped onto this virtual model. As a result, implant holes are created, which finalizes the creation of the master model. What is special with this method is the soft tissue model. An algorithm is developed to combine two datasets and derive the tissue model.

For a bone-borne case, the process is similar. Only the patient is scanned, jaw bone is segmented with the scan data, and the master model with implant holes is created. The term “jaw bone” in this document means a combination of the bone and teeth. For fully edentulous cases, it refers to bone only. For partially edentulous cases, it refers to the model with soft tissue filtered, and hence both the bone and teeth are included as shown in FIG. 5.

For both categories of these cases, implant inserts are created. Each insert has a cylindrical segment fitting into the implant holes, and an extension that is meant to create the holes on the surgical guides. The said holes will be the places to insert drilling sleeves of surgical guides.

The master model and implant inserts are manufactured with rapid prototyping technology. Since they will not be placed into patients' mouth, biocompatibility of the RP material is not a concern. Instead, multiple color printing can be used. The master model and inserts can be assembled together as a study model from this point on, and as a base for manufacturing a surgical guide. They enable the surgeon to further study the patient's anatomy and to plan the case with tooth extraction, bone reduction, etc., and to evaluate the accessibility of drilling tools before actually making the surgical guide.

### DESCRIPTION OF THE DRAWINGS

FIG. 1. The hybrid workflow of treatment planning includes four phases: digital treatment planning, master model CAD/CAM, model-based planning, and surgical guide making.

FIG. 2. Different views of a reconstructed jaw bone model. The transparent one shows the nerve channels. On the top of the model is the X-ray scatters. They need to be removed by the treatment planning software, but this is not a topic of this document.

FIG. 3. The nerve channel model. The left picture shows a clipped bone image and a volume segmentation of the nerve channel. The right picture shows a surface model of the nerve channel, which is created by a tracking algorithm.

FIG. 4. The master model of an upper jaw. The first picture is the reconstructed bone model, the second is the master mode that is trimmed with a bounding box and has the implant holes.

FIG. 5. The master model of a lower jaw.

FIG. 6. The cross sections of the bone and the nerve model. The material within the white circle is the intersection between the two models.

FIG. 7. The internal shells of the bone model are removed. This bone and nerve can be assembled together. The bone model can further subtract the nerve model to make an internal shell corresponding to the nerve.

FIG. 8. The actual nerve channel is bigger than the nerve model in this shown section. If this is true for most area of the nerve model, the nerve can not be positioned within the bone if they are manufactured with RP as combined model. A support structure might be needed in order to maintain the right position of the nerve model.

FIG. 9. This illustrates the design of an implant insert, which will be inserted into the master model to reflect the underlying implant and to be used for making a surgical guide. The illustrated soft tissue layer is only for the cases requiring tissue-level surgical guides.

FIG. 10. The summary of the master model concept. A master model includes the component corresponding to the patient anatomy and geometric features to the treatment plan.

FIG. 11. The hybrid workflow is illustrated by planning a tooth extraction. In the digital planning stage, an implant is placed for the teeth to be extracted. The master model is manually modified to simulate the tooth extraction in the model-based planning stage.

FIG. 12. EZ Stent—Thermoplastic Surgical Template is used to make the surgical guide from master model. The parameters of the master model and inserts are specially configured for the templates.

FIG. 13. Workflow for tissue-borne cases. It also includes four phases: digital treatment planning, master model CAD/CAM, model-based planning, and surgical guide making. The major difference is that the master model includes soft tissue surfaces or a separated model of the tissue.

FIG. 14. Tissue and tooth surface is generated by extracting the inward surface of the radiographic guide. The left side is the guide. The screen orientation is the user defined model extraction direction. The right side shows the extracted inward surface with color map reflecting the distance between the model and jaw bone.

FIG. 15. The soft tissue model is created from the surface in FIG. 13. The second picture shows the master model. The third the master model and surgical guide.

### DETAILED DESCRIPTION OF THE INVENTION

### Digital Treatment Planning

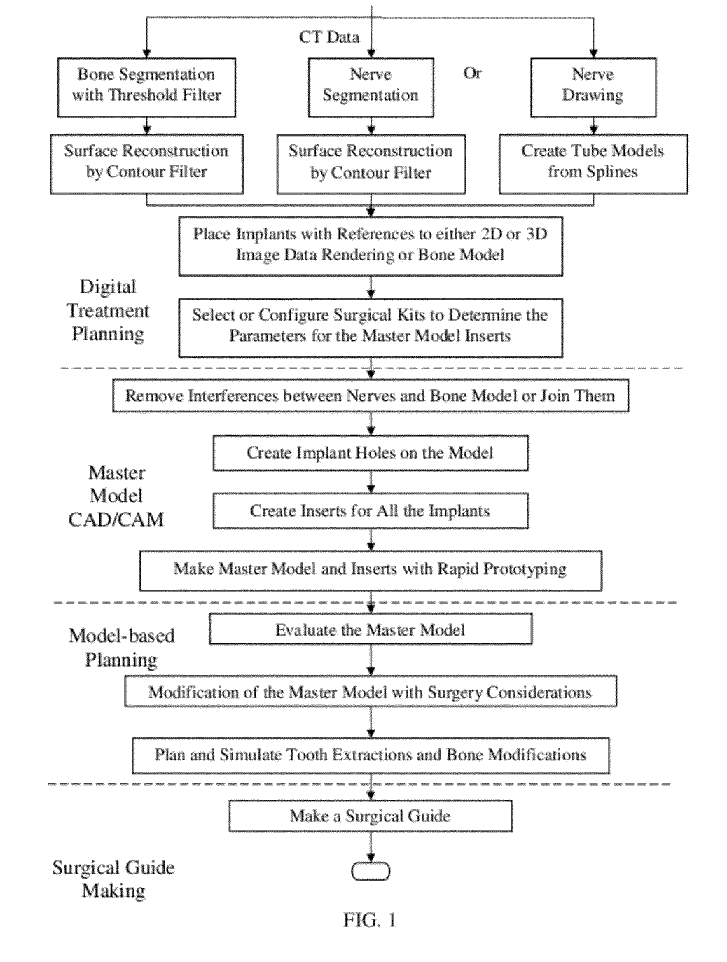

FIG. 1 is the overall workflow of this approach when a bone-level surgical guide is needed. The workflow includes four phases, namely, digital treatment planning, master model CAD/CAM, model-based planning, and surgical guide making.

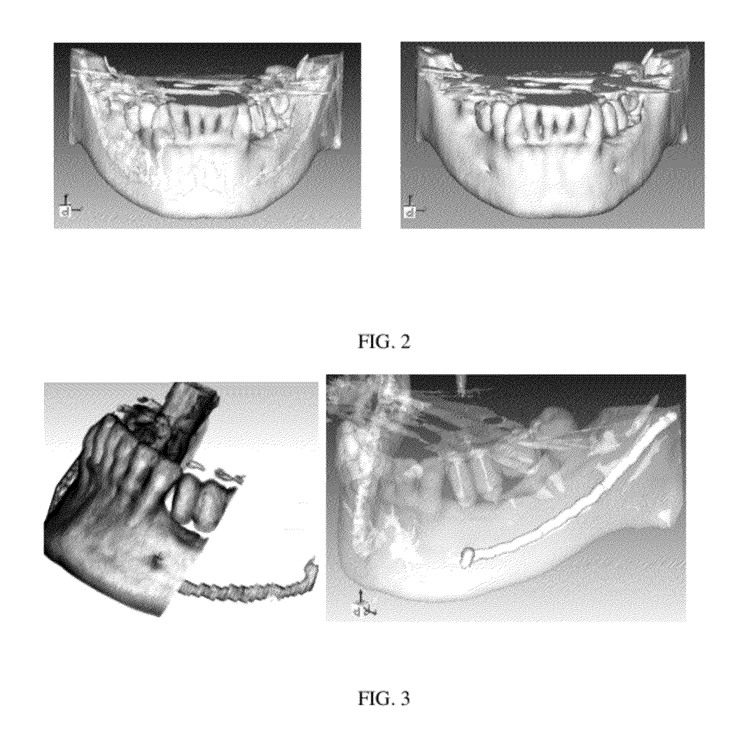

In the first step, the CT scan data is loaded into the software system. The jaw model is then created by thresholding and surface reconstruction. Since CT data is grayscale based, thresholding will easily segment out the jaw bone. For the mandible, the jawbone will also show the tubular chamber where the nerves run through. FIG. 2 shows different views of a reconstructed jaw bone model. The picture in the left side shows the nerve channels with transparency. On the top of the model is the X-ray scatters. They need to be removed by the treatment planning software, but this is not a topic of this document. Next the surface reconstruction of the bone structure will create a triangulated surface model and export it as s an .stl file.

In a preferred embodiment, the nerve channels for a mandible case will also be created and assembled with the jawbone model as shown in FIG. 3. In the computer graphics display, the nerve model and the jawbone have different colors. There are many ways to extract nerve models. A popular way is to place a couple of knots in CT image slices, and generate a tube with those points in the center spline. In FIG. 3 the left picture shows a clipped bone image and a volume segmentation of the nerve channel. The right picture shows a surface model of the nerve channel, which is created by a tracking algorithm.

Implants are then placed with respect to the jawbone. The implants can be placed using either 3D CT slices or the 3D model, and displayed together with the jawbone and the nerve structure in 3D display window.

### Master Models

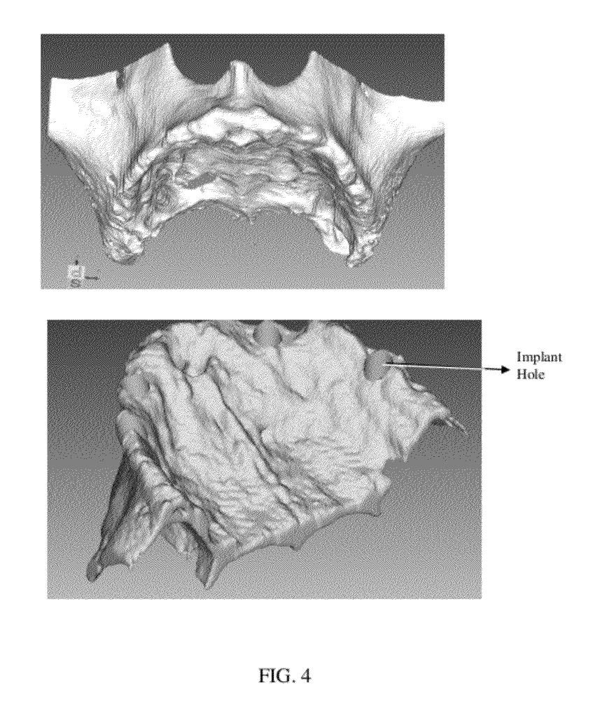

The second phase of the workflow in FIG. 1 will create implant holes on the jawbone model. Using the upper jaw as an example shown in FIG. 4, the jaw bone model is trimmed with a bounding box. The implant holes are added to the model. This is the master model for a bone-level upper jaw case. Each implant corresponds to one hole. A cylinder with the diameter equal to that of the implant is used as a tool body, and placed in the position where the implant is. A geometric modeling operation is performed to subtract the cylinder from jaw model. In order for the surgeons to better evaluate a case, the tool body should have the same shape of the implant except the threads. A preferred embodiment would use a tapered cylinder if the implant is tapered.

There are variations to these holes depending on the treatment plan. Sometimes, implant treatment can be planned for pilot drills only; and sometimes for all drilling sequences. When only pilot drills are concerned, the implant holes on the master model are typically 2 mm. Otherwise, the diameters will be those of the implants. It is worthwhile to mention that such variations reflects the underlying treatment plan, while a normally found study model may be just a plaster model with implant holes.

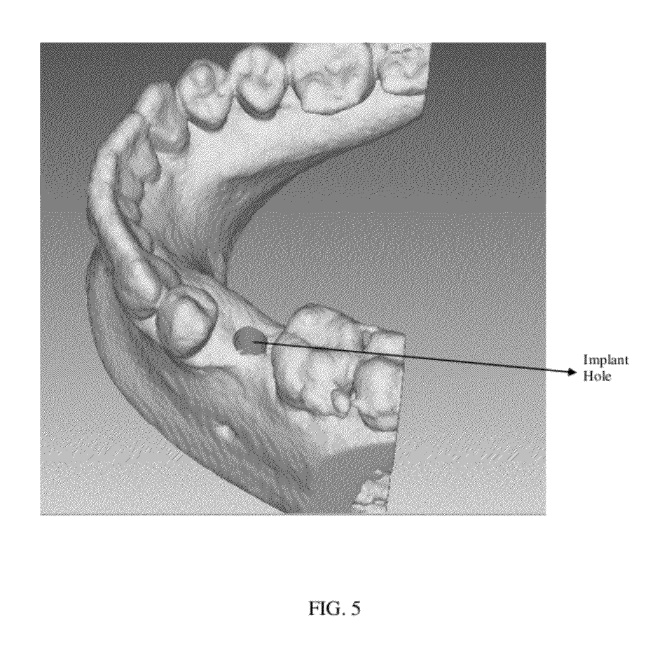

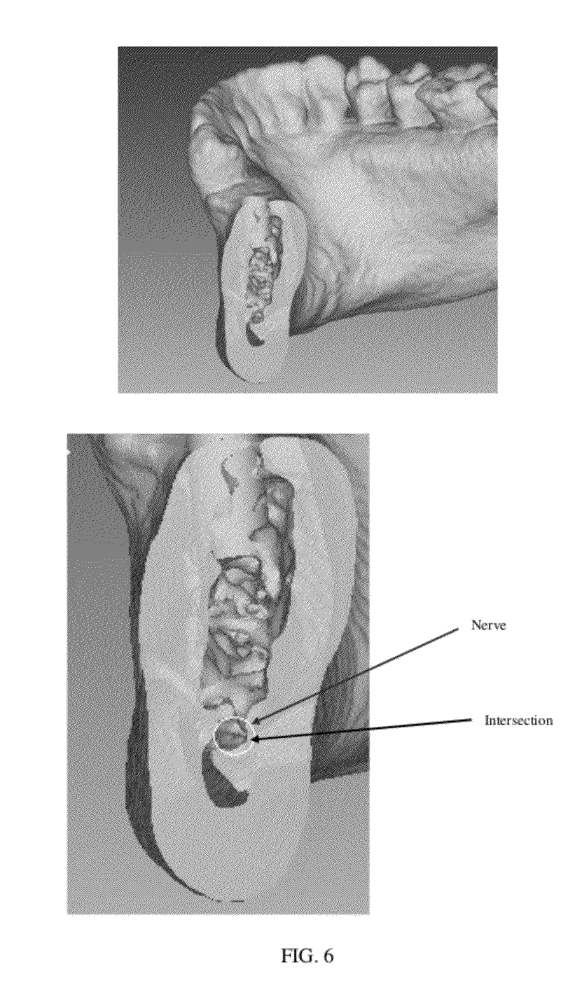

For the lower jaw, the master model is the assembly of such a model and the nerve model. FIG. 5 is a partially edentulous case without showing the nerve model. The never model can intersect with the jaw model for various reasons. If the nerve structures are extracted with image processing, they theoretically won't interfere with the jaw model, but the facts that the images are voxel-based, the segmentation of the nerves and the bones can share some voxels in the space. This results in the interferences between the two. Another factor is the surface reconstruction algorithm, which can also introduce errors. When the nerve models are manually drawn as implemented in many software systems, the tubes can very likely intersect with the jaw model. This intersection is illustrated in FIG. 6 by a cross section. The second picture shows the cross section of the nerve model and its intersection with the bone.

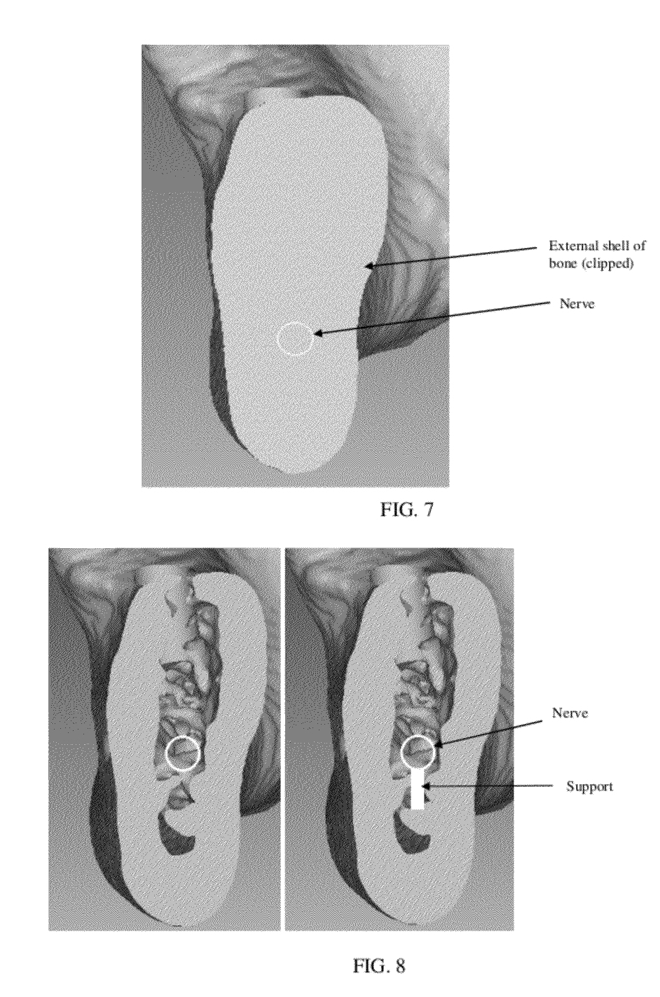

A simple way to assemble the jaw and nerve model is just to segment the external shell of the jaw model and remove the internal surfaces, and then assemble the nerve model and the jaw model into multiple shells, which can be manufactured by the RP equipment. This is illustrated in FIG. 7.

However, one of the objectives of this invention is to have a master model that can be used to further evaluate and plan the treatment, thus having internal structure or surfaces of the jaw bone model is important, especially when the model can be made with non-opaque materials. In the preferred embodiment, Boolean operations will be used to subtract the nerve models from the jaw bone model, and then the models can be assembled.

On the other hand, since the nerves reside in the nerve channel of the jaw bone, it is possible that the nerve models are not connected to the jaw model. This is true especially when the patient's jaw has significant bone loss. In order for the nerves to be well supported inside the jaw model some additional objects can be created to join them together. See FIG. 8 for an illustration.

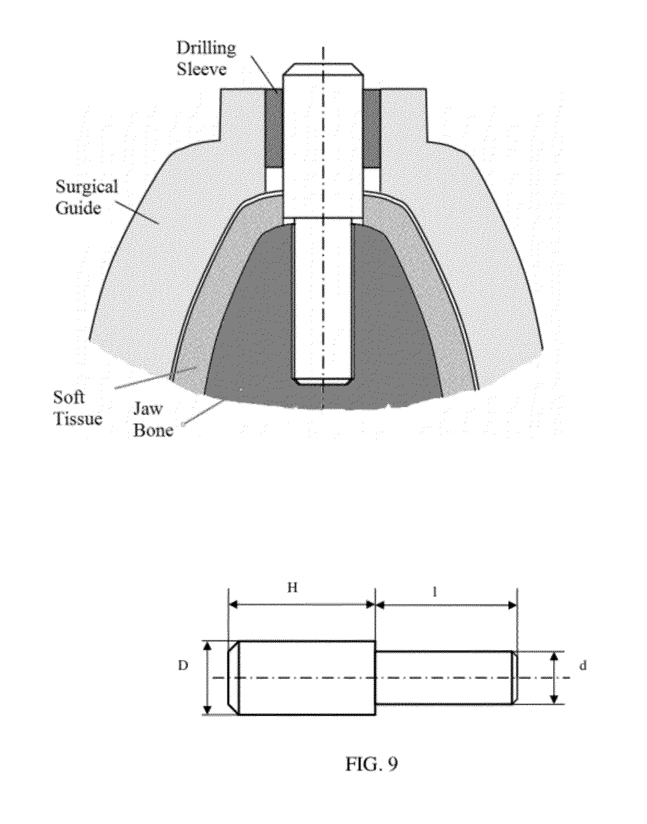

In addition, implant inserts corresponding to the implant holes are designed and made. FIG. 9 illustrates the design of an insert. One end of an insert is a cylinder slightly smaller than the implant hole. Its diameter is about 0.05 mm-0.1 mm smaller, and length is about 1 mm longer. The actual length is calculated so that the jaw bone will be penetrated through. At another end is a cylindrical extension long enough to go through both the soft tissue and the surgical guide that will be designed and made from it. In this figure, the design is illustrated with soft tissue. For cases using bone level guides, this tissue layer will not be in the picture. The diameter of the upper extension is the inner diameter of the drilling sleeve minus an assembly clearance of for example 0.05-0.1 mm. Drilling sleeves are metal tubes inserted into the surgical guides in order to guide the actual drills. The design and usage of drilling sleeve is where the different surgical guide vendors differ from each other.

Similar to the variations of the implant holes, the inserts can have variations too. First, the ends inserted into the bone model can have the diameters of the implants or pilot drills, typically 2 mm, depending on the treatment plan. Secondly, the ends for surgical guides may have different diameters according to the internal diameters of the drilling sleeve. For pilot drills, 2 mm will be used. If a surgical kit such as NobelBiocare's will be used in the surgery, the sleeve internal holes will be the same size as the implant mounts, which is slightly bigger than the implants, therefore the inserts will have diameters of the implant mounts. If the surgical kit is not designed this way, or no kit will be used, the diameters of the implants will be just used for the top of the inserts. Therefore an insert is not a simple replica of an implant. It conveys the treatment plan information regarding to the drilling sequence choice and the surgical kit selection. More information about the surgical kit configuration can be found in patent application Ser. No. 12/795,045 (Gao, June 2010).

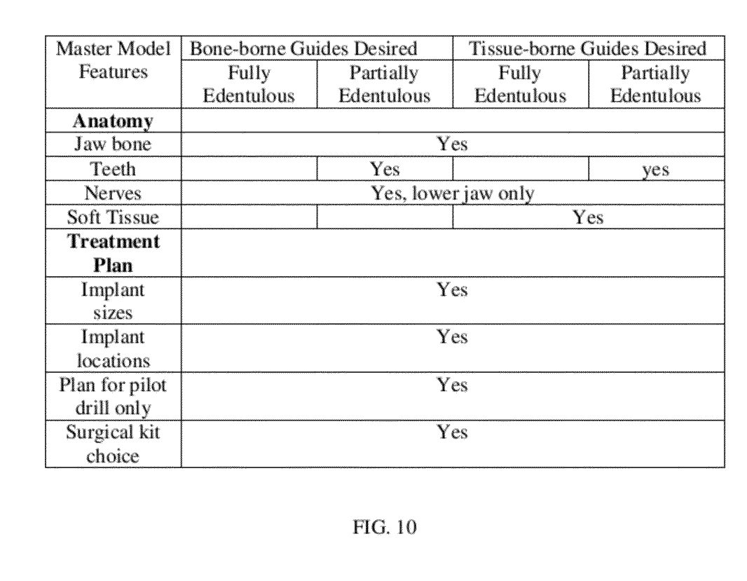

The concept of the master model including the inserts is summarized in FIG. 10. The patient anatomy and treatment plan information are all embodied by this model. The anatomy components depend on the underlying cases, and the treatment plan information is conveyed by the implant holes and inserts.

The master model and the inserts can be then made with rapid prototyping or 3D printing systems. Since this is just a replica of the patient anatomy and implants, and will not be used in the surgery, any RP approach and material will be good. With recent technology it is possible to print the nerves with one color and the jaw bone another color. For those with single material and color, the bone and nerve can still be printed together as an assembly.

### Model-Based Planning

Before making a surgical guide, the lab or the dental office can do so-called model-based planning. As mentioned above a jaw model resulted from the thresholding tends to have problems. This has been addressed in the application “Method and software system for treatment planning and surgical guide CAD/CAM” (U.S. patent application Ser. No. 12/795,045). After a jaw model is manufactured, it is very easy to smooth it with normal lab techniques. For example, all the undercuts can be identified and masked. The small dents and holes can be filled with materials. Unnecessary parts of the model can be trimmed.

A master model can be further evaluated by the technicians or surgeons to check if there is enough space for the drilling tools to reach the implant locations. The treatment plan can be now reviewed with this physical model before a surgical guide is manufactured. The implant positions and orientations can be visually checked against the nerve models. Other clinical evaluations regarding to the applicability of model and treatment plan can also be done.

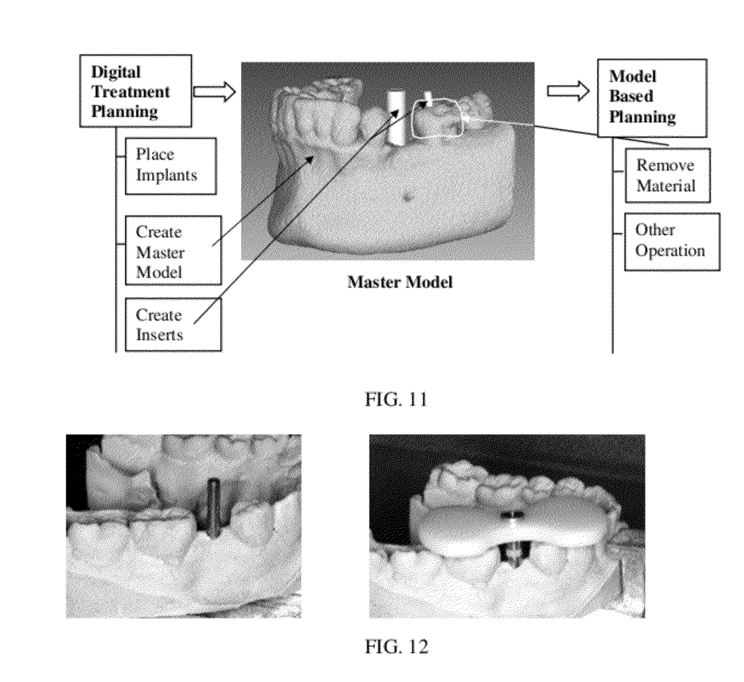

Tooth extraction can very well demonstrate the benefits of hybrid planning workflow. In many cases tooth extractions and bone modifications are necessary. Those can now be planned and simulated with the master model and the inserts. FIG. 11 shows how a tooth extraction is planned. At the digital planning stage an implant can be planned at the location while the tooth is still there. The master model and the implant insert are made accordingly as shown in the figure. In order to show the variations of the master model in this case, one implant is planned for pilot drill only, so the diameter of the insert is only 2 mm. A technician can simply remove the tooth and adjacent material from the master model to simulate tooth extraction. In a conventional procedure, the tooth needs to be extracted first, and the CT scan is done after the location heals. As mentioned by Schmidt (U.S. patent application Ser. No. 11/867,590) there is a need to avoid this healing and waiting.

The bone reduction or grafting can also be planned with a master model. A technicians or surgeon can just add or remove materials from the jaw bone model until the model is as desired. At the time of surgery the surgeon is about to do the same to the patient's jaw bone before the implants can be placed. Controlling how the reduction or grafting is done is not the topic of this invention.

### Surgical Guide Manufacturing

After all the planning and evaluation are accomplished, the lab or the dental office can make surgical guides using the master models and inserts. The procedure is very much same as making any dentures with a plaster model. It is important that even though guides can be made by the software vendors, it is more preferable for the offices and labs to fabricate the guides. The advantage of this approach is that all the conventional approaches to make surgical stents can all be used. The easiest way may be through acrylic molding. The inserts are all assembled with the master model, and then an acrylic model is poured. The thickness of the acrylic model can be determined by the lab in addition to a recommended setting. Since this is a manual process the technician can decide to strengthen areas that seem to be weak. After the guide is made, the inserts are pulled out, and drilling sleeves are put in place.

FIG. 12 shows another approach that EZ Stent (Thermoplastic Surgical Template™) can be easily adapted to make surgical guides with a master model. The template is a piece of thermoplastics that can be reshaped in hot water and becomes hard when the temperature goes down. It has a predrilled hole and drilling sleeve. A template can be put onto the master model with the inserts in place, and reshaped to fit the model. Since the prefabricated templates come with sleeves, the inserts' parameters shown in FIG. 9 are different. In other words, the software system is configured to make inserts specially designed for such templates.

### Workflow for Tissue-Borne Cases

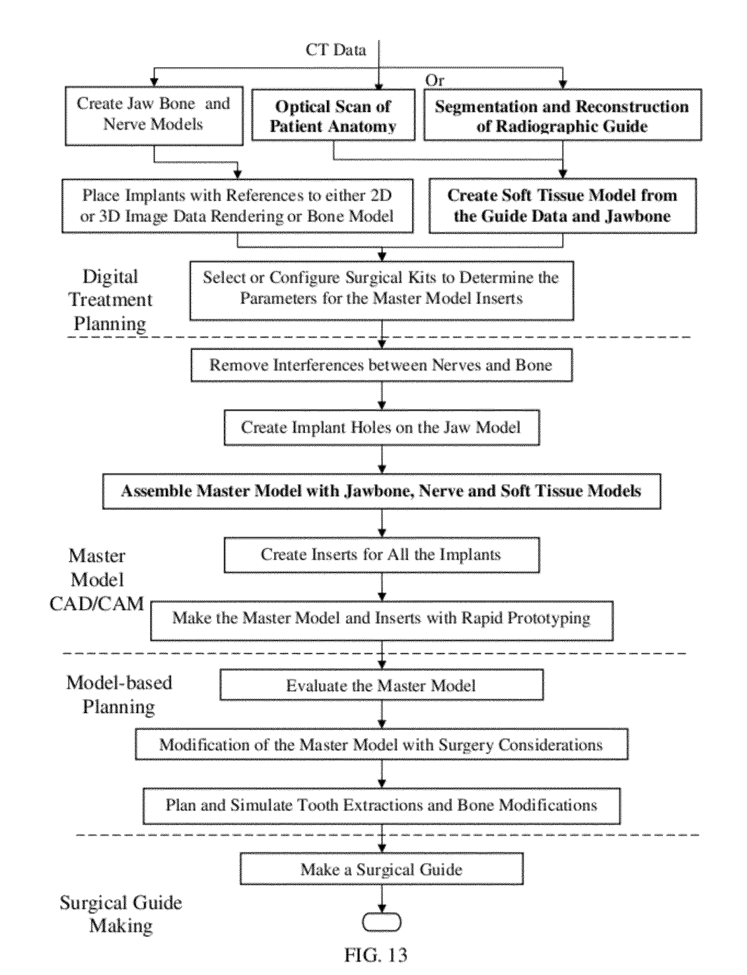

FIG. 13 is the workflow for a tissue-borne case. Since the surgical guide will be placed onto patients' soft tissue, one needs to have a replica of the soft tissue surface. This is the major difference between FIG. 13 and FIG. 1.

One way to get the soft tissue surface is to create a soft tissue model in addition to the jaw bone model. The implant holes will be also added to the soft tissue model. As a result a master model is the assembly of bone model, soft tissue model, nerve model if applicable, and the inserts.

A preferred embodiment is to use the inward surface of the radiographic guide as the tissue surface. This is shown in FIG. 14. First, an extraction direction is specified for the radiographic guide. In the figure, the guide is rotated to face the user. The normal of the view plane is the extraction direction. This model is separated into two sets of faces by their normal directions. One set faces toward the jaw bone, one outward. The first set is actually a combination of the soft tissue surface, tooth surfaces, etc. Since the objective of creating the “soft tissue surface” is to replicate the patient anatomy so that the surgical guide can be made out of it, the inward surface of radiographic guide will serve this purpose well. Therefore, the so-called tissue model will be a model actually including both tissue and tooth surfaces.

In FIG. 14, the holes from the radiographic guide have been filled with modeling technology. This needs to be done because there is supposed to be no such holes in the patient's anatomy.

Another point to mention is that color map is used to show the distances between this soft tissue model and the jaw bone. The color map not only shows the thickness of soft tissues, but also reflects the fitting of the radiographic guide. For example, the distance between the “tissue model” and the tooth surface of the jaw bone model is supposed to be zero because the radiographic guide should fit right onto the teeth. In this picture, the white color means the distance is zero. In the actual computer display, there are much more color levels. However, with this specific case, the surfaces in the molar area are way off the tooth surface, which indicates that this radiographic guide is not well positioned or fabricated. In some clinical cases, the radiographic guide is tilted when the patient is being scanned wearing the guide, so the distance map can show if one side is farther than another. This gives us a tool to evaluate the fitting of the radiographic guide and to identify the problems. This has not been seen in other publications or software systems.

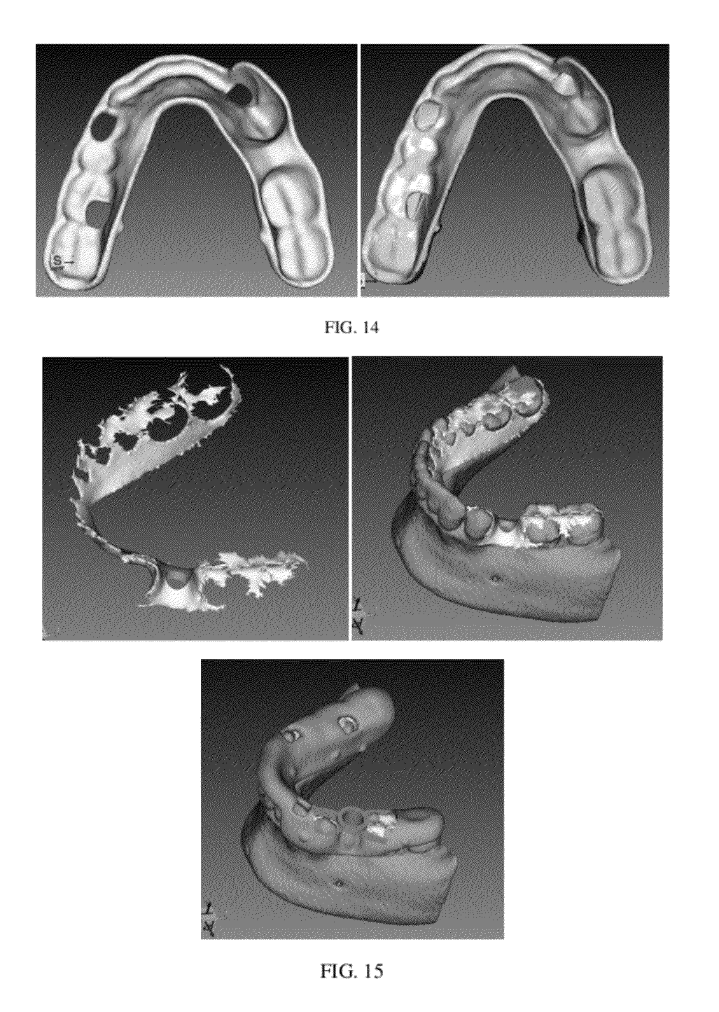

FIG. 15 shows how a virtual soft tissue model will eventually look like. The surface from FIG. 14 is extruded toward and trimmed by the jaw bone model to make a close solid model. Again, the molar area shows some materials because there is actually gap between the radiographic guide and the teeth. The implant holes will be of course added to the model. With color printing, one can print the nerve model, the jaw model and the virtual soft tissue model together.

Alternatively this soft tissue model can be united with the jawbone model to make a so different form of the master model. The advantage of this is that only one model will be created, and there won't be any concern that the inner surface of the tissue model will not exactly matched with the jaw bone model. The mismatch can happen because of the algorithm accuracy.

Another approach to creating a master model with the soft tissue surfaces is to use optical scanning technology. The model can be acquired by an optical scan of the conventional stone model or an intra-oral scan of the patient anatomy. In other words, a virtual stone model is created, and then the treatment plans are transferred onto it by adding implant holes.

Within the software system, the jaw model, the implants and the radiographic guide model are put into the same coordinate systems with the registration of CT image data as mentioned above. The optical scan has its own coordinate system. The software will need to register it with the radiographic guide model so that implant holes can be added to the optical scan. The goal of this registration is to align part of this optical scan data with part of the radiographic guide model. A modified Iterative Closest Point (ICP) algorithm is used to do this registration. ICP is the most common method to align two point clouds. In order to do this partial alignment, we need to choose from the scan model an area that is overlapped with the radiographic guide.

The rest of the workflow for the tissue-borne guides is same as the bone-borne cases as shown in FIG. 1. The lab or dental office can perform the same model evaluation and modification, and then make surgical guides with the same procedure.

What is claimed is:

1. A hybrid dental implant treatment planning workflow, wherein
1) digital treatment planning is performed with CT scan data,
2) a master model is created by the treatment planning software with implant holes added,
3) model-based planning is further performed with the master model if necessary, and
4) optionally, a surgical guide is manufactured based on the master model.

2. Computer generated master model to enable the approach or workflow in claim 1, which has
1) a patient's bone model,
2) optionally a soft tissue model and a nerve model, and
3) geometric features fully reflecting the digital treatment plan information including implant positions, sizes, surgical guide drilling options, as well as the choice of surgical kits.

3. A method to make a dental implant surgical guide with the master model according to claim 1, comprising the steps of:
1) planning an implant case with CT scan data,
2) creating a master model with patients' anatomical structure and implant holes,
3) creating implant inserts,
4) manufacturing the said master model and inserts with preferably rapid prototyping or 3D printing,
5) evaluating the made models,
6) if necessary, continuing treatment planning by modifying made master model to simulate the tooth extractions or bone modifications, and
7) making a surgical guide with molding or prefabricated templates.

4. The method to create master models for a bone-borne maxillary (upper jaw) implant case according to claim 1 and 2, wherein the jaw bone structure is segmented from CT image data, and implant holes are added onto the bone model with parameters reflecting the treatment plan.

5. The method to create a master model for a bone-borne mandible (lower jaw) implant case according to claim 1 and 2, wherein
1) jaw bone structure is segmented from CT image data,
2) nerve channel models are created from CT image data or manual drawing if desired, and
3) implant holes are added onto the model with parameters reflecting the treatment plan.

6. The method to create a master model for a tissue-borne maxillary (upper jaw) implant case according to claim 1 and 2, wherein
1) the jaw bone structure is segmented from CT image data,
2) the soft tissue model is created from CT scan data or optical scan,
3) the soft tissue model is united with or trimmed by jaw bone structure, and
4) implant holes are added onto the model with parameters reflecting the treatment plan.

7. The method to create a master model for a tissue-borne mandible (lower jaw) implant case according to claim 1 and 2, wherein
1) the jaw bone structure is segmented from CT image data,
2) the soft tissue model is created from CT scan data or optical scan,
3) the soft tissue model is united with or trimmed by jaw bone structure, and
4) nerve channel models are created from CT image data or manual drawing if desired, and
5) implant holes are added onto the base models with parameters reflecting the treatment plan.

8. The method to make a soft tissue model according to claim 6 and 7, comprising the following steps:
1) the surface model of a radiographic guide is separated into two areas, one touching the patients anatomy, and one not, and
2) a solid model is created to enclose the space between the jaw bone model and the said area touching the patient anatomy.

9. The method to make a master model with soft tissue surfaces according to claim 6 and 7 with optical scans, comprising the following steps:
1) obtaining an optical scan of a conventional plaster model,
2) registering the optical scan with the radiographic guide model with computer program using the surface data,
3) transferring the implant parameters onto this model, and
4) assembling this model with the jaw bone and nerve models.

10. The method to design implant inserts according to claim 1, wherein one end of an insert is determined by the corresponding implant and to be mated with the corresponding master model and another end determined by the surgical guide sleeve and selected surgical kits.

11. The treatment planning method for tooth extraction and bone modification according to claim 1, wherein
1) treatment planning is first performed with the CT scan of existing anatomy,
2) a master model reflecting the existing anatomy and treatment plan is created by the procedure according to one of the claim from 4 through 7 and manufactured by RP or 3D printing,
3) the treatment planning is continued by simulating the tooth extraction and bone modification with the made master model,
4) the master model is modified accordingly, and
5) eventually a surgical guide is made with the modified master model.

12. The approach to assess the fitting of radiographic guide and patient anatomy using the techniques from claim 8, wherein
1) the thickness of soft tissue model is created and visually inspected, or the distance map between the radiographic guide and patient jaw bone model is computed and analyzed, and
2) the findings like asymmetric distribution of the distances, or the unexpected distances between the guide and the tooth surface are reported as possible problems.
